(19) United States
(12) Patent Application Publication
(10) Pub. No.: US 2026/0280785 A1
(43) Pub. Date: Sep. 17, 2026

(54) METHODS AND NODES FOR RECIPROCITY-BASED INTERFERENCE-AWARE UL TRANSMISSIONS

(71) Applicant: TELEFONAKTIEBOLAGET LM ERICSSON (PUBL), Stockholm (SE)

(72) Inventors: Sven JACOBSSON, VÄSTRA FRÖLUNDA (SE); Andreas NILSSON, Goteborg (SE); Siva MURUGANATHAN, Stittsville (CA)

(21) Appl. No.: 19/162,480

(22) PCT Filed: Mar. 15, 2024
(86) PCT No.: PCT/IB2024/052536

§ 371 Date: Sep. 5, 2025

Related U.S. Application Data
(60) Provisional application No. 63/452,391, filed on Mar. 15, 2023.

(51) Int. Cl. H04L 5/00; H04B 7/06

(52) U.S. Cl. CPC H04L 5/0044; H04B 7/0626

(57) ABSTRACT

There is provided a method performed by a user equipment (UE) for transmitting and/or receiving data with a network node. The method comprises: receiving a first downlink reference signal (DL-RS) from a first set of DL-RSs and a second DL-RS from a second set of DL-RSs, wherein the first set of DL-RSs are associated with a desired uplink (UL) transmission and the second set of DL-RSs are associated with a non-desired UL transmission; performing measurements on the received first and second DL-RSs; determining uplink precoders based on the measurements; and sending, to a network node, a UL reference signal using the determined precoders.

### RELATED APPLICATIONS

This application claims the benefits of priority of U.S. Provisional Patent Application No. 63/452,391, entitled “RECIPROCITY-BASED INTERFERENCE-AWARE UL TRANSMISSION” and filed at the United States Patent and Trademark Office (USPTO) on Mar. 15, 2023, which is hereby incorporated by reference in its entirety.

### TECHNICAL FIELD

This application relates to wireless communication networks and more specifically to methods and nodes for reciprocity-based interference-aware Uplink (UL) transmissions.

### BACKGROUND

### Uplink (UL) Transmission/Precoding Schemes

The channel that carries data in the New Radio (NR) UL is called Physical Uplink Shared Channel (PUSCH). In NR, there are two possible waveforms that can be used for PUSCH: cyclic prefix (CP)-Orthogonal frequency division multiplexing (OFDM) and Discrete Fourier Transform (DFT) spread (DFT-S)-OFDM. Also, there are two transmission schemes specified for PUSCH: codebook (CB)-based precoding and non CB (NCB)-based precoding.

In 5G NR, the gNode B (gNB) configures, in Radio Resource Control (RRC), the transmission scheme through the higher-layer parameter “txConfig” in the PUSCH-Config Information Element (IE) as defined in Third Generation Partnership Project (3GPP) TS 38.331. CB-based transmission can be used for non-calibrated User Equipments (UEs) and/or for Frequency-division duplexing (FDD) (i.e., when UL/downlink (DL) reciprocity does not need to hold). NCB-based transmission, on the other hand, relies on UL/DL reciprocity and is, hence, intended for Time Division Duplex (TDD).

### NCB-Based Precoding

NCB-based UL transmission is for reciprocity-based UL transmission in which Sounding Reference Signal (SRS) precoding is derived at a UE based on Channel State Information (CSI)-Reference signal (RS) received in the DL. Specifically, the UE measures received CSI-RS and deduces suitable precoder weights for SRS transmission(s), resulting in one or more (virtual) SRS ports, each corresponding to a spatial layer.

In NR, a UE can be configured with up to four SRS resources (up to eight SRS resource will be introduced in Rel-18), each with a single (virtual) SRS port, in an SRS resource set with higher-layer parameter usage in SRS-Config IE defined in 3GPP TS 38.331 set to ‘nonCodebook’. A UE transmits the up to four (eight, in NR Rel-18) SRS resources and the gNB measures the UL channel based on the received SRS and determines the preferred SRS resource(s). Next, the gNB indicates the selected SRS resources via the SRS Resource indicator (SRI) field in Downlink Control Information (DCI) and the UE uses this information to precode PUSCH with a transmission rank that equals the number of indicated SRS resources (and, hence, the number of SRS ports).

### SRS

In NR, SRS is used for providing CSI to the gNB in the UL. The usage of SRS includes, e.g., deriving the appropriate transmission/reception beams and/or to perform link adaptation (i.e., setting the transmission rank and the Modulation and Coding Scheme (MCS)), and for selecting DL (e.g., for Physical Downlink Shared Channel (PDSCH) transmissions) and UL (e.g., for PUSCH transmissions) MIMO precoding.

In NR, SRS is configured via RRC, where parts of the configuration can be updated (for reduced latency) through Medium Access Control (MAC)-Control Element (CE) signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the DCI in the Physical Downlink Control Channel (PDCCH) which instructs the UE to transmit the SRS once, at a predetermined time.

When configuring SRS transmissions, the gNB configures, through the SRS-Config 1E, a set of SRS resources and a set of SRS resource sets, where each SRS resource set contains one or more SRS resources.

### SRS Configuration

AS RS resource is configured through SRS-Resource IE in RRC (see ASN code in 3GPP TS 38.331 version 16.1.0).

An SRS resource is configurable with respect to, e.g.,
1) The number of SRS ports (1, 2, or 4), configured by the RRC parameter nrofSRS-Ports.
2) The RRC parameter resource Type determines whether the SRS resource is transmitted as periodic, aperiodic (single transmission triggered by DCI), or semi persistent (same as periodic except for the start and stop of the periodic transmission is controlled through MAC-CE signaling instead of RRC signaling).
3) The RRC parameter spatialRelationInfo configures the spatial relation for the SRS beam with respect to another RS (which could be another SRS, an SSB or a CSI-RS). If an SRS resource has a spatial relation to another SRS resource, then this SRS resource should be transmitted with the same beam (i.e., virtualization or spatial Transmission filter) as the one used to transmit the indicated SRS resource.

An SRS resource set is configured through SRS-ResourceSet IE in RRC (see ASN code in 3GPP TS 38.331 version 16.1.0).

SRS resource(s) will be transmitted as part of an SRS resource set, where all SRS resources in the same SRS resource set must share the same resource type. An SRS resource set is configurable with respect to, e.g.,
1) The resource usage, which is configured by the RRC parameter usage sets constraints and assumptions on the resource properties as defined in 3GPP TS 38.214. SRS resource sets can be configured with one of four different usages: ‘antennaSwitching’, ‘codebook’, ‘nonCodebook’ and ‘beamManagement’.
2) An SRS resource set that is configured with usage ‘nonCodebook’ is used for NCB-based UL transmission. Specifically, the UE transmits one SRS resource per candidate beam (suitable candidate beams are determined by the UE based on CSI-RS measurements in the DL and, hence, reciprocity needs to hold). The gNB can then, by indicating a subset of these SRS resources, determine which UL beam(s) that the UE should apply for PUSCH transmission. One UL layer will be transmitted per indicated SRS resource. Note that how the UE maps SRS ports to antenna ports is up to UE implementation and not known to the gNB.
3) The associated CSI-RS (this configuration is only applicable for NCB-based UL transmission) for each of the possible resource types.
   a) For an aperiodic SRS, the associated CSI-RS resource is set by the RRC parameter csi-RS as defined in 3GPP TS 38.331.
   b) For semi-persistent/periodic SRS, the associated CSI-RS resource is set by the RRC parameter associatedCSI-RS as defined in 3GPP TS 38.331.

### Channel State Information (CSI) and CSI Feedback

A core component in NR is the support of MIMO antenna deployments and MIMO related techniques. Spatial multiplexing is one of the MIMO techniques used to achieve high data rates in favorable channel conditions.

In the DL, the precoder matrix is typically selected from a codebook of possible precoder matrices, and typically reported by a precoder matrix indicator (PMI), which specifies a unique precoder matrix in the codebook for a given number of symbol streams. The rank of the channel and is reported by a rank indicator (RI). For a given block error rate (BLER), a modulation level and coding scheme (MCS) is determined by a UE based on the observed signal to noise and interference ratio (SINR), which is reported by a channel quality indicator (CQI).

NR supports transmission of either one or two transport blocks (TBs) to a UE in a slot, depending on the rank. One TB is used for ranks 1 to 4, and two TBs are used for ranks 5 to 8. A channel quality indicator (CQI) is associated to each TB. The CQI/RI/PMI report can be either wideband or subband based on configuration. RI, PMI, and CQI are part of the CSI and reported by a UE to a network node or gNB.

### CSI-RS and CSI-Interference Measurement (IM)

A CSI-RS is transmitted on each transmit antenna port and is used by a UE to measure downlink channel associated with each of antenna ports. The antenna ports are also referred to as CSI-RS ports. The supported number of antenna ports in NR are {1, 2, 4, 8, 12, 16, 24, 32}. By measuring the received CSI-RS, a UE can estimate the channel the CSI-RS has experienced, including the radio propagation channel and antenna gains. CSI-RS for this purpose is also referred to as non-zero power (NZP) CSI-RS.

NZP CSI-RS can be configured to be transmitted in certain REs per PRB.

In addition to NZP CSI-RS, zero power (ZP) CSI-RS was defined in NR to indicate to a UE that the associated REs are not available for PDSCH scheduling at the gNB. ZP CSI-RS can have the same Resource Elements (RE) patterns as NZP CSI-RS.

CSI resource for interference measurement (CSI-IM) is also defined in NR for a UE to measure noise and interference, typically from other cells. CSI-IM comprises of four REs in a slot. Two different CSI-IM patterns are defined: The CSI-IM pattern can be either four consecutive REs in one OFDM symbol or two consecutive REs in both frequency and time domains. Typically, the gNB does not transmit any signal in the CSI-IM resource so that what is observed in the resource is noise and interference from other cells.

### SUMMARY

There currently exist certain challenge(s). UL coverage and/or capacity is becoming a bottleneck in current communication systems, and this is expected to be an issue also in future communication systems. One example of this is the UL capacity problem seen in midband fixed wireless access (FWA) deployments. One reason for the capacity problem in UL is due to excessive UL inter-cell interference (for both UL Singler User (SU)-MIMO and Multiple User (MU)-MIMO) and UL intra-cell interference (for MU-MIMO).

To mitigate UL interference, the UE needs to precode its UL transmissions considering the interference in the UL. How to enable the UE to perform interference-aware uplink precoding is an open problem to be solved. For example, for NCB-based precoding, the UE virtualization of SRS resources (i.e., the UL precoding) is based on CSI-RS transmitted in the DL, and, hence, UL inter/intra-cell interference is not considered.

Certain aspects of the disclosure and their embodiments may provide solutions to these or other challenges. Some embodiments describe different signaling and configuration methods on how to enable reciprocity-based interference-aware UL transmission.

Some embodiments introduce signaling and configurations that enable the UE to determine both spatial directions of desired signals and spatial directions for non-desired (interference) directions, which are used for reciprocity-based interference-aware UL precoding.

According to an aspect, there is provided a method performed by a UE for transmitting and/or receiving data with a network node. The method comprises: receiving a first DL-RS from a first set of DL-RSs and a second DL-RS from a second set of DL-RSs, wherein the first set of DL-RSs are associated with a desired UL transmission and the second set of DL-RSs are associated with a non-desired UL transmission; performing measurements on the received first and second DL-RSs; determining uplink precoders based on the measurements; and sending, to a network node, a UL reference signal using the determined precoders. There is also provided a UE for carrying this method out.

According to another aspect, there is provided method performed by a network node, for transmitting and/or receiving data with a UE. The method comprises: transmitting a first DL-RS from a first set of DL-RSs and a second DL-RS from a second set of DL-RSs, wherein the first set of DL-RSs are associated with a desired uplink (UL) transmission and the second set of DL-RSs are associated with a non-desired UL transmission; receiving, from a user equipment (UE), a UL reference signal using a precoder determined by the UE based on the transmitted first and second DL-RSs; determining a precoder based on the received UL reference signal; and sending an indication of the determined precoder to the UE. A network node for carrying out this method is also provided. A computer program product comprising a computer readable memory is also provided, configured to perform the above methods.

Certain embodiments may provide one or more of the following technical advantages. By enabling reciprocity-based interference-aware UL transmission, UL interference can be mitigated which, in turn, improves UL throughput and UL capacity.

### BRIEF DESCRIPTION OF THE DRAWINGS

Exemplary embodiments will be described in more detail with reference to the following figures, in which:

FIG. 1 illustrates examples of different scenarios in which embodiments of this disclosure can be used, e.g. FIG. 1a illustrates a coordinated inter-Transmission Reception Point (TRP) interference mitigation (where different TRPs are tightly connected to a common coordinator entity/scheduler, FIG. 1b illustrates a non-coordinated inter-TRP interference mitigation (with poor coordination between the different TRPs, e.g. where different TRPs use different schedulers) and FIG. 1c illustrates an intra-TRP interference mitigation (i.e. single TRP UL MU-MIMO).

FIG. 2 illustrates a signaling diagram between a UE and a network node for reciprocity-based interference-aware UL transmissions, according to an embodiment.

FIG. 3 illustrates a schematic example of a method for reciprocity-based interference-aware UL transmissions with 2 TRPs, according to an embodiment.

FIG. 4 illustrates a schematic example of a method for reciprocity-based interference-aware UL transmissions with 3 TRPs, according to an embodiment.

FIG. 5 illustrates a flow chart of a method in a UE, according to an embodiment.

FIG. 6 illustrates a flow chart of a method in a network node, according to an embodiment.

FIG. 7 shows an example of a communication system, according to an embodiment.

FIG. 8 shows a schematic diagram of a UE, according to an embodiment.

FIG. 9 shows a schematic diagram of a network node, according to an embodiment.

FIG. 10 illustrates a block diagram of a host.

FIG. 11 illustrates a block diagram illustrating a virtualization environment.

FIG. 12 shows a communication diagram of a host.

### DETAILED DESCRIPTION

Some of the embodiments contemplated herein will now be described more fully with reference to the accompanying drawings. Embodiments are provided by way of example to convey the scope of the subject matter to those skilled in the art.

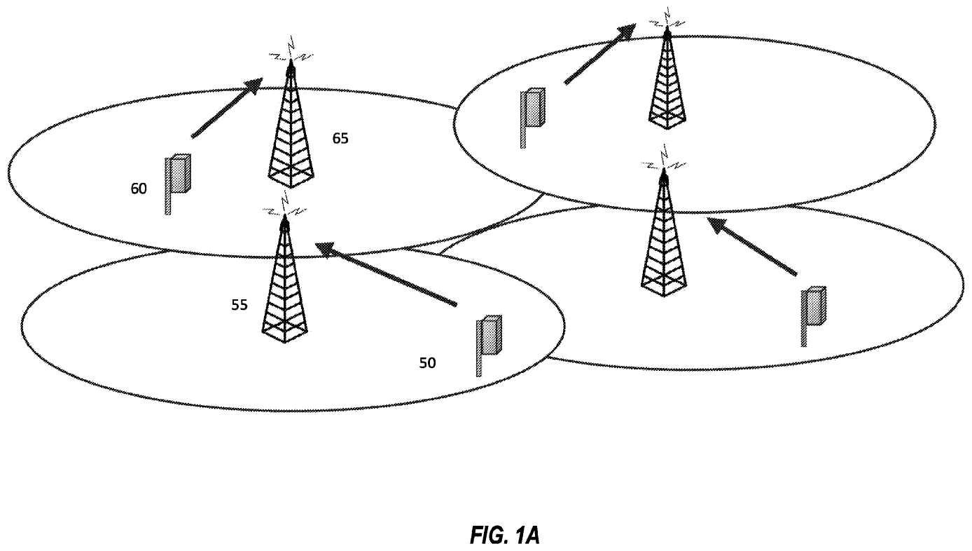

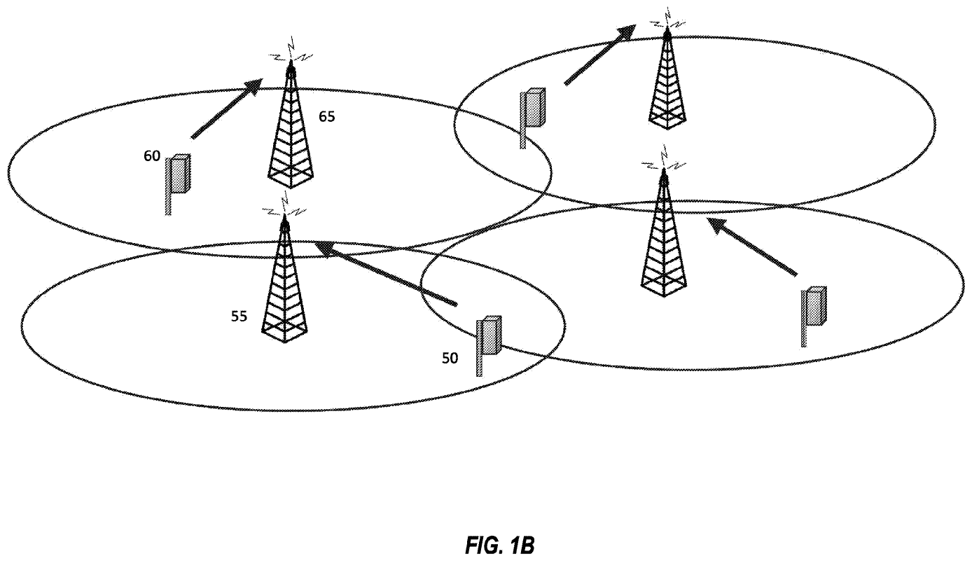

FIG. 1 illustrates three different scenarios where some embodiments of the disclosure can be used. The scenarios are illustrated for FWA deployments, but the current disclosure is not limited to FWA deployments but could be applicable to other deployments and different types of UEs.

FIG. 1A illustrates coordinated inter-Transmission Reception Point (TRP) interference mitigation (where different TRPs are tightly connected to a common coordinator entity/scheduler). FIG. 1B illustrates non-coordinated inter-TRP interference mitigation (with poor coordination between different TRPs, e.g., where the different TRPs are using different schedulers). FIG. 1C illustrates intra-TRP interference mitigation (UL MU-MIMO).

In the first two scenarios of FIG. 1, the focus is mainly on reducing UL inter-cell interference (i.e., interference caused by a first UE 50 served by a first TRP 55 towards a second TRP 65 that is serving a second UE 60), where the first scenario assumes coordinated TRPs, and the second scenario assumes TRPs with limited/poor coordination. In the third scenario, the focus is mainly on reducing the intra-cell interference between different UEs served by the same TRP and scheduled for UL MU-MIMO. It should be noted that Scenario 3 can be combined with Scenario1 and Scenario 2, so the scope of the current disclosure is not limited to these three scenarios. These scenarios are just included to facilitate the description of the current disclosure. The different embodiments presented in this disclosure might be better suited for different scenarios. In some embodiments, for the scenario in FIG. 1A: Configure a UE with one NZP-CSI-RS resource to be used for increasing signal strength at serving TRP and X number of NZP-CSI-RS resources used for reducing interference towards non-serving TRPs. In some embodiments, for the scenario in FIG. 1B: Configure a UE with one NZP-CSI-RS resource to be used for increasing signal strength at serving TRP and X number of CSI-IM resources used for estimating interference and use that to reduce interference towards non-serving TRPs. In some embodiments, for the scenario in FIG. 1C: Configure a UE with one NZP-CSI-RS resource to be used for increasing signal strength at serving TRP and X number of NZP-CSI-RS resources used for reducing interference towards non-serving TRPs.

In one embodiment, a UE is configured for UL transmissions where the UE is configured with a first set of DL-RS(s) and a second set of DL-RS(s), and where the first set of DL-RS(s) are associated with a desired UL transmission (e.g., the UE should try to maximize the transmitted power for UL signals/channels in the direction(s) associated with the received one or more DL-RS(s) belonging to the first set of DL-RS(s)) and the second set of DL-RS(s) are associated with a non-desired UL transmission (e.g., the UE should try to minimize the transmitted power for UL signals/channels in the direction(s) associated with the received one or more DL-RS(s) belonging to the second set of DL-RS(s)). For example, the UE can use Signal-to-Leakage-and-Noise Ratio (SLNR) or Minimum Mean Squared Error (MMSE) precoding method to focus the power of the transmitted UL signal/channel in directions associated with the first set of DL-RSs while, at the same time, minimizing the power of the transmitted UL signal/channel in directions associated with the second set of DL-RSs.

In one embodiment, the second set of DL-RS (i.e., the DL-RS used to determine non-desired directions for the transmitted UL signals/channels) are based on non-zero power DL-RS (e.g., NZP CSI-RS in NR) from TRP(s) other than the serving TRP. In this case the UE can e.g., measure and estimate the channel between the UE and the interfering TRPs and use that information to determine a suitable UL precoder.

In one embodiment, the second set of DL-RS(s) only indicate resources that can be used by the UE to measure interference (e.g., CSI-IM in NR), but that are not dedicated DL-RS(s) actually transmitted from the interfering TRPs. Instead, the UE measures interference based on transmission of other signals/channels from the interfering TRPs.

In one embodiment, the second set of DL-RS(s) consist of a dedicated set of resources indicated by the serving TRP.

In one embodiment, the second set of DL-RS(s) consist of both non-zero power DL-RS from TRP(s) other than the serving TRP and a dedicated set of resources indicated by the serving TRP.

In one embodiment, the first set of DL-RS(s) and second set of DL-RS(s) are associated with a set of UL-RS(s). In one embodiment, the UE should precode the UL-RSs based on the measurements performed on the first set of DL-RS(s) and the second set of DL-RS(s), such that the power of the transmitted UL-RSs is maximized in directions associated with the first set of DL-RSs and minimized in directions associated with the second set of DL-RS(s). In one embodiment, after the transmission of the UL-RS, the network indicates a precoder indication (e.g., using SRI, as in NCB-based precoding in NR) that are associated with the transmitted UL-RS(s), and the UE use the indicated precoders to transmit a scheduled UL data channel (e.g., PUSCH).

Note that the number of DL-RS(s) in the first and second set of DL-RS(s) can be one or more than one. Note that the number of UL-RS(s) in the set of UL-RS(s) can be one or more than one.

In one embodiment, the set of UL-RS(s) is configured by a single UL-RS resource set. In one embodiment, the set of UL-RS(s) is configured by more than one UL-RS resource set. In one embodiment, each UL-RS resource set consist of one or more UL-RS resource(s). In one embodiment each UL-RS resource consist of one or more UL-RS port(s). In one embodiment, the first set and second set of DL-RS(s) are configured in the information element of the associated UL-RS resource set(s), for example using RRC signaling, or some other signaling introduced in 6G.

In one embodiment, the DL-RS is a NZP CSI-RS and/or CSI-IM as specified in NR or a modified/new version of CSI-RS introduced in 6G. In one embodiment, the DL-RS is a new DL-RS introduce in 6G. In one embodiment, the UL-RS is an SRS as specified in NR or a modified/new version of SRS introduced in 6G. In one embodiment, the UL-RS is a new UL-RS introduced in 6G.

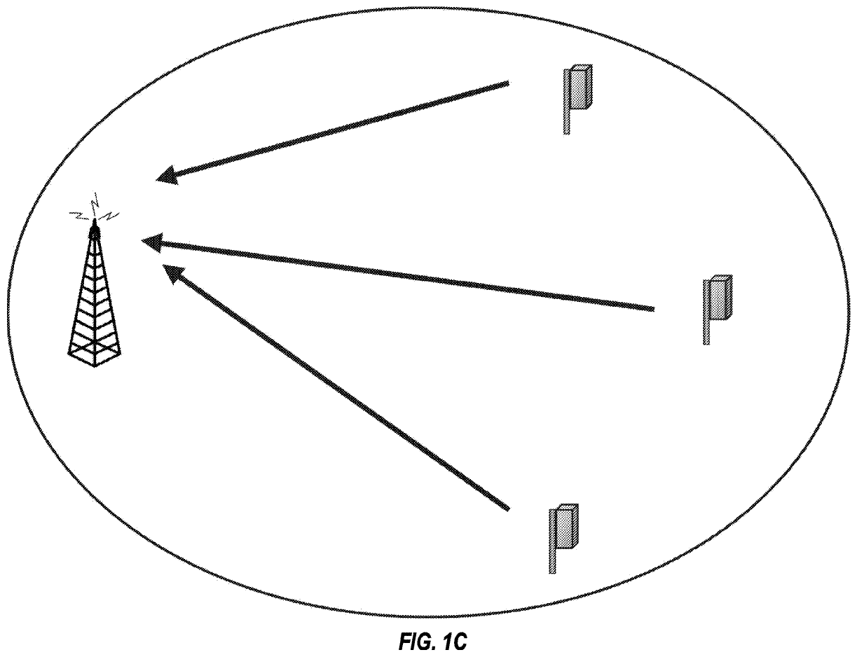

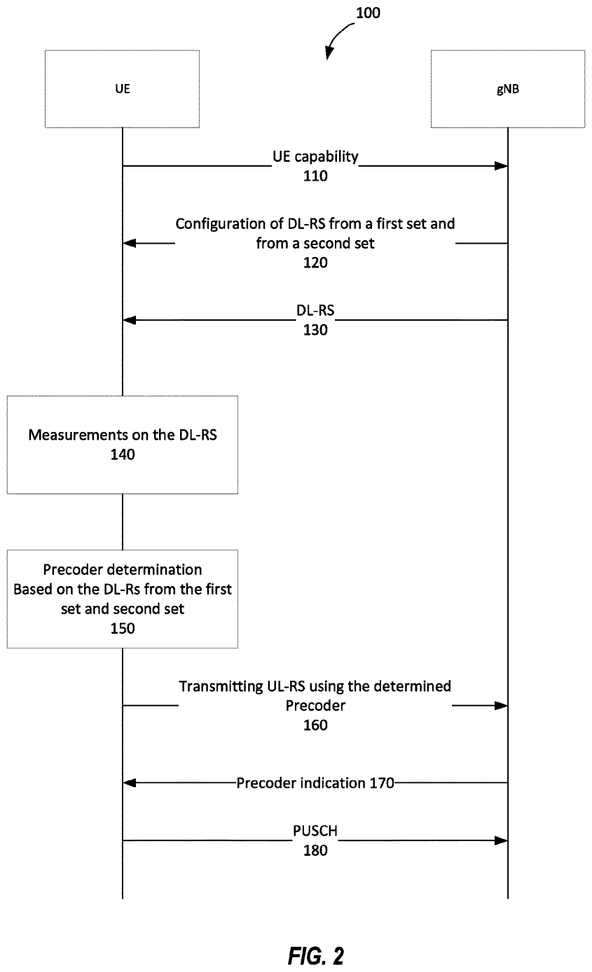

An example of a signaling diagram 100 between a UE and a gNB for communicating with each other, based on the above, is illustrated in FIG. 2. For example, in step 110, the UE 50 can (optionally) send to the gNB 55 a UE capability, which indicates that the UE supports reciprocity-based interference aware UL transmissions. In step 120, the gNB sends a configuration to the UE. The configuration comprises the configuration of a first DL-RS from a first set of DL-RSs and a second DL-RS from a second set of DL-RSs, with the first set of DL-RSs associated with a desired UL transmission and the second set of DL-RSs associated with a non-desired UL transmission. The configuration can also comprise a configuration for UL-RSs, such as SRS. In step 130, the gNB sends the DL-RSs to the UE. It should be noted that the gNB may encompass several TRPs. As such, one TRP can send the first DL-RS from the first set to the UE and another TRP can send the second DL-RS from the second set to the UE. In step 140, the UE performs measurements on the received first and second DL-RSs. The UE then determines in step 150 a precoder based on the first and second DL-RSs (or on the measurements on the first and second DL-RSs). In step 160, the UE sends a UL-RS (such as an SRS) using the determined precoder to the gNB. The gNB can also determines a precoder (plus rank, MCS, etc.) based on the received UL-RS. In step 170, the gNB sends to the UE an indication of the precoder that it has determined. In step 180, the UE uses the received precoder to send its uplink transmissions, such as PUSCH.

As described in the background section, in current NR specification it is possible to associate an SRS resource set with usage ‘nonCodebook’ with a single NZP-CSI-RS resource to enable reciprocity-based UL precoding, where the UE can use the NZP-CSI-RS to determine desired spatial directions when precoding the SRS resources in the SRS resource set.

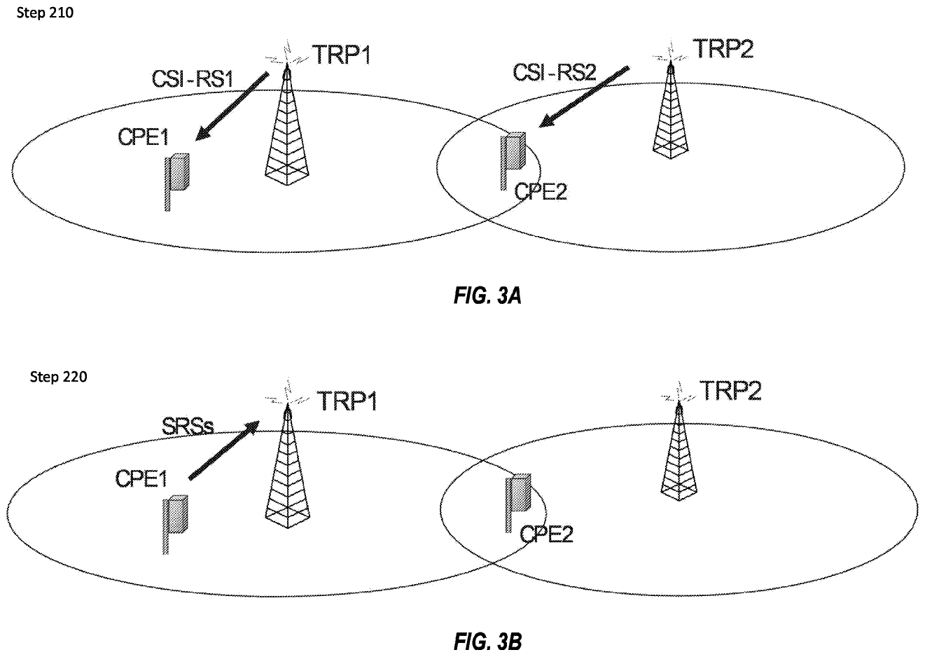

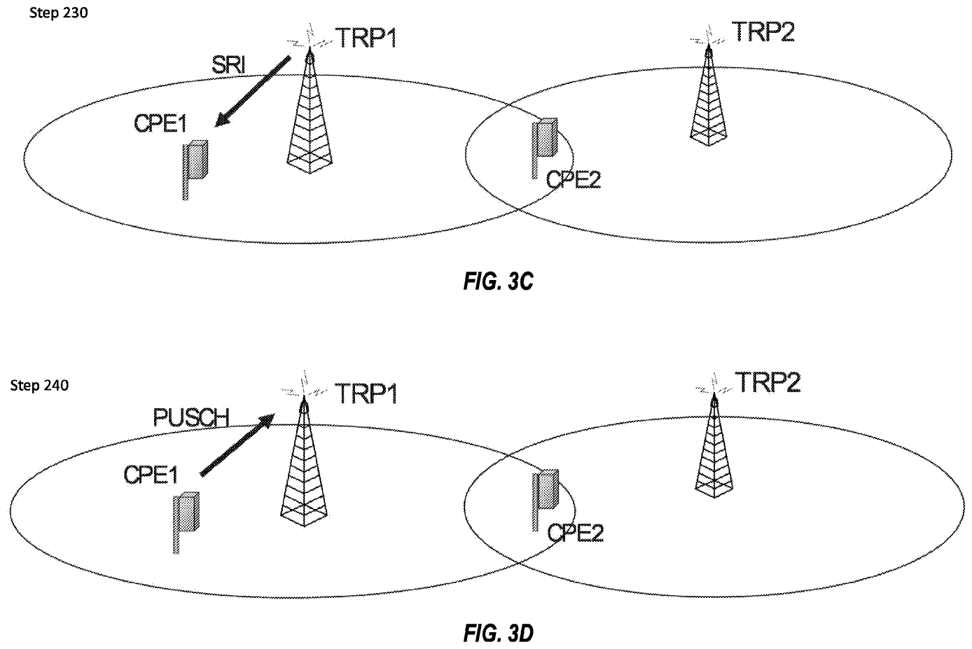

In one embodiment, a second set of NZP-CSI-RS resource(s) is configured in an SRS resource set with usage ‘nonCodebook’, which can be used by the UE to determine non-desired spatial directions for the SRS resources in the SRS resource set. One example of this embodiment and how it could be used is described in FIG. 3. Here it is assumed that the UE (a Consumer Premise(s) Equipment (CPE) device, in the following example) is configured with one SRS resource set with usage ‘nonCodebook’, and where the SRS resource set has been configured with one NZP-CSI-RS resource used to determine desired directions for UL signals/channels (for example by re-using the legacy parameters “csi-RS” or “associatedCSI-RS”, or adding a new parameter) and one NZP-CSI-RS used to determine non-desired (interference) directions (which could be added in a new parameter).

In Step 210 (shown in FIG. 3A), TRP1 transmits a CSI-RS1, and TRP2 transmits a CSI-RS2 and CPE1 performs measurements and channel estimates based on both CSI-RS1 and CSI-RS2 (measurements on the same CSI-RS transmissions can be performed simultaneously by CPE2, but for simplicity the method is only described for CPE1).

In Step 220 (shown in FIG. 3B), CPE1 determines UL precoders (for example, using MMSE precoding) where CPE1 tries to maximize the received power at the TRP1, while, at the same time, minimize the interference generated towards TRP2, and then transmits SRS(s) using the determined precoder(s).

In Step 230 (shown in FIG. 3C), TRP1 receives the SRS, determines preferred UL rank and UL precoder(s), and signals back the information to CPE1 using the SRS resource indicator (SRI) in the DCI scheduling a PUSCH transmission.

In Step 240 (shown in FIG. 3D), CPE1 transmits PUSCH using the indicated UL precoders.

This embodiment is mainly applicable to Scenario1 and Scenario3 (or a combination thereof), since the TRPs transmitting the two CSI-RS resources need to be synchronized/coordinated for a CPE/UE to receive them properly and perform the measurements/channel estimations.

One example of how the above embodiment can be implemented in NR is illustrated below (where the new parameters are highlighted in bold). Note that this is just one example of how this embodiment can be implemented in NR.

In another embodiment, a new SRS usage is introduced in NR, where the usage is specifically targeting UL interference aware SRS transmission, and where an SRS resource set with the new usage can be configured with both the first set of NZP-CSI-RS(s) (using legacy parameters or new parameters) and the second set of NZP-CSI-RSs (using new parameters).

Below illustrates a schematic example of the embodiment where a first set of NZP-CSI-RS resources are configured in an SRS resource set with usage ‘nonCodebook’ using the legacy parameters “CSI-RS” or “associatedCSI-RS”, and where the second set of NZP-CSI-RS are configured with new parameters “csi-RS_List_for_interference” or “associatedCSI-RS_List_for_interference”.

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) OF |

SRS-ResourceId

| | |
|---|---|
| resourceType | CHOICE { |
| aperiodic | SEQUENCE { |
| aperiodicSRS-ResourceTrigger | INTEGER (1..maxNrofSRS-TriggerStates-1), |
| csi-RS | NZP-CSI-RS-ResourceId |
| csi-RS_{—}List_{—}for_{—}interference | SEQUENCE (SIZE(1..maxNrofCSI-RS-for- |

interference)) OF NZP-CSI-RS-ResourceId

| | |
|---|---|
| slotOffset | INTEGER (1..32) |

```
      ...,
      [[
```

| | |
|---|---|
| aperiodicSRS-ResourceTriggerList | SEQUENCE (SIZE(1..maxNrofSRS- |

TriggerStates-2))

OF INTEGER (1..maxNrofSRS-TriggerStates-1)

```
      ]]
    },
```

| | |
|---|---|
| semi-persistent | SEQUENCE { |
| associatedCSI-RS | NZP-CSI-RS-ResourceId |
| associatedCSI-RS_{—}List_{—}for_{—}interference | SEQUENCE |

```
(SIZE(1..maxNrofCSI-RS-for-interference)) OF NZP-CSI-RS-ResourceId
      ...
    },
```

| | |
|---|---|
| periodic | SEQUENCE { |
| associatedCSI-RS | NZP-CSI-RS-ResourceId |

```
        associatedCSI-RS_List_for_interference SEQUENCE (SIZE(1..maxNrofCSI-RS-
for-interference)) OF NZP-CSI-RS-ResourceId
          ...
    }
```

In one embodiment, the second set of DL-RS(s) consist of CSI-IMs instead of NZP-CSI-RS. In this case, the UE will not receive a dedicated reference signal to determine the non-desired directions, but instead the UE can receive other (unknown by the CPE/UE) signals/channels transmitted by the non-serving TRPs, and based on these received signals/channels the UE can estimate how strong the interference is in different directions. Based on the estimated interference from other TRPs, the CPE/UE can determine a precoder that maximizes the signal strength towards the desired directions and minimize the signal strength towards non-desired directions (for example using SLNR precoding). This embodiment is especially useful for Scenario2 as it does not require any special coordination between the different TRPs.

In one embodiment, a UE is configured with both NZP-CSI-RS and CSI-IM to determine the non-desired UL directions. For example, the UE can use the NZP-CSI-RS to determine the non-desired directions for the non-serving TRPs that are tightly connected/synchronized with the serving TRP, and use the CSI-IM to determine the non-desired directions for the non-serving TRPs that are not tightly connected to the serving TRP.

In another embodiment, three sets of NZP-CSI-RS resource(s) are configured in an SRS resource set with usage ‘nonCodebook’, where the UE shall precode the SRS based on the measurements performed on all three sets of NZP-CSI-RS resource(s) such that:
the power of the transmitted SRS is maximized in the directions associated with two of the three sets of NZP-CSI-RS resource(s); and
the power of the transmitted SRS is minimized in the direction associated with one of the three sets of NZP-CSI-RS resource(s).

This is useful in multi-TRP scenarios where the UE transmits to multiple TRPs in the UL. For instance, if the UE transmits to two TRPs in the UL, the above two of the three sets of NZP-CSI-RS resource(s) correspond to the NZP-CSI-RS(s) transmitted from the two TRPs to which the UE transmits in UL. In some embodiments, the UE may transmit to the two TRPs simultaneously. In some other embodiments, the UE may transmit to the two TRPs in a time-division multiplexing (TDM) fashion. When the UE transmits to the two TRPs in a TDM fashion, the UE may transmit to the two TRPs either:
in cyclic fashion (i.e., the UE transmits to TRP1 in slot 1, transmits to TRP2 in slot 2, transmits to TRP1 in slot 3, transmits to TRP2 in slot 4, etc.); or
in sequential fashion (i.e., the UE transmits to TRP1 in slots 1 and 2, the UE transmits to TRP2 in slots 3 and 4, etc.).

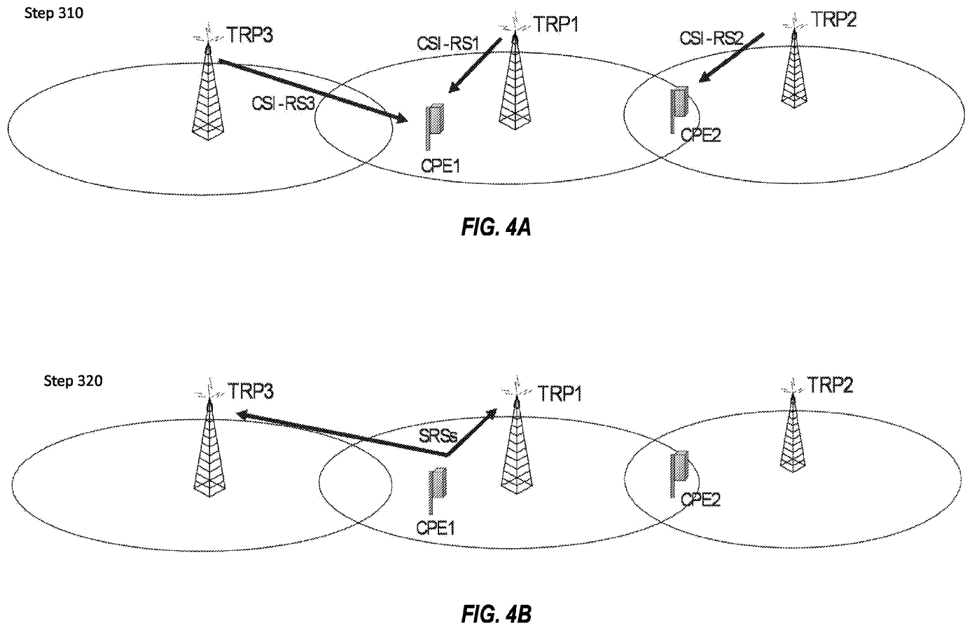

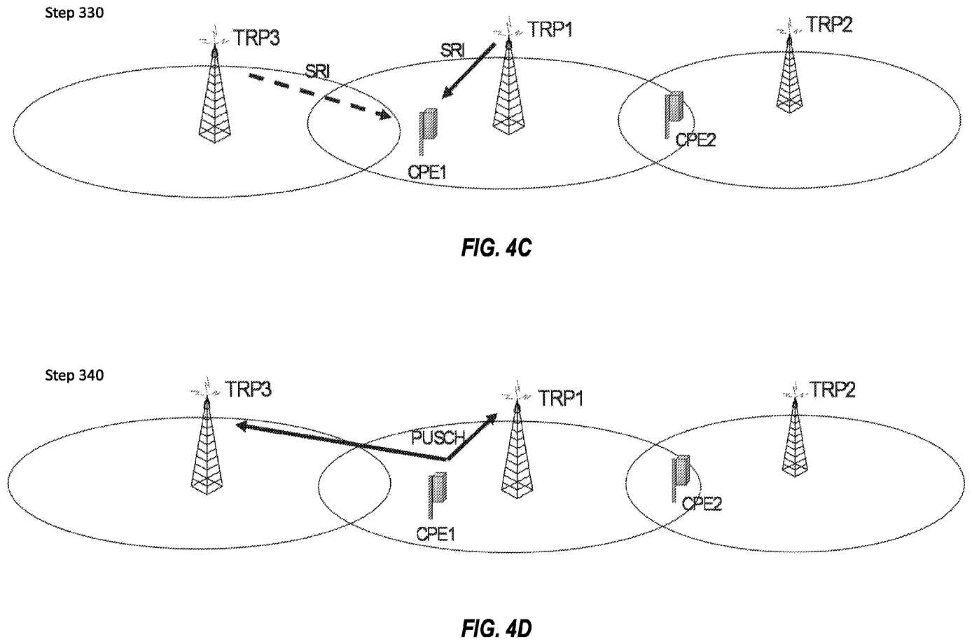

One example of this embodiment is shown in FIG. 4. Here it is assumed that the UE is configured with one SRS resource set with usage ‘nonCodebook’, and where the SRS resource set has been configured with two NZP-CSI-RS resources used to determine desired directions for UL signals/channels (for example by re-using the legacy parameters “csi-RS” or “associatedCSI-RS”, or adding a new parameter) and one NZP-CSI-RS used to determine non-desired (interference) directions (which could be added in a new parameter).

In Step 310 (shown in FIG. 4A), TRP1 transmits a CSI-RS1, TRP3 transmits a CSI-RS3, and TRP2 transmits an CSI-RS2 and CPE1 performs measurements and channel estimates based on CSI-RS1, CSI-RS3 and CSI-RS2.

In Step 320 (shown in FIG. 4B), CPE1 determines UL precoders (for example, using MMSE precoding) where the CPE1 tries to maximize the received power(s) at TRP1 and TRP3, and minimize the interference generated towards TRP2, and then transmits SRS(s) using the determined precoder(s).

In Step 330 (shown in FIG. 4C), TRP1 and TRP3 receive the SRS(s), determine preferred UL rank and UL precoder(s), and signals back the information to the UE using one or multiple SRI(s). In some embodiments, only TRP1 transmits SRI to CPE1. In another embodiment, both TRP1 and TRP3 transmit the SRIs to CPE1.

In Step 340 (shown in FIG. 4D), the CPE1 transmits PUSCH using the indicated UL precoders towards TRP1 and TRP3.

In yet another embodiment, three sets of NZP-CSI-RS resource(s) are configured in an SRS resource set with usage ‘nonCodebook’, where the UE shall precode the SRS based on the measurements performed on all three sets of NZP-CSI-RS resource(s) such that: the power of the transmitted SRS is maximized in the directions associated with one of the three sets of NZP-CSI-RS resource(s); and the power of the transmitted SRS is minimized in the direction associated with two of the three sets of NZP-CSI-RS resource(s).

This embodiment is useful when a potentially interfering UE transmits to two TRPs in the UL. For instance, if the interfering UE transmits to two TRPs in the UL, the above two of the three sets of NZP-CSI-RS resource(s) correspond to the NZP-CSI-RS(s) transmitted from the two TRPs to which the interfering UE transmits in UL. In this case, it is desired to minimize the power of the transmitted SRS in the direction associated with two TRPs to which the interfering UE is transmitting to.

In one embodiment, the UE signals during UE capability signaling, that it supports one or more of the embodiments described in the current disclosure (i.e., some kind of interference aware UL transmission). This UE capability signaling might also contain one or more of the following information:
Maximum (max) number of NZP-CSI-RS resources configured for interference estimation.
Max number of CSI-RS ports per NZP-CSI-RS resource configured for interference estimation.
Max total number of CSI-RS ports over all NZP-CSI-RS resources configured for interference estimation.
Max number of CSI-IM resources configured for interference estimation.
Max total number of NZP-CSI-RS resources and CSI-IM resources configured for interference estimation.

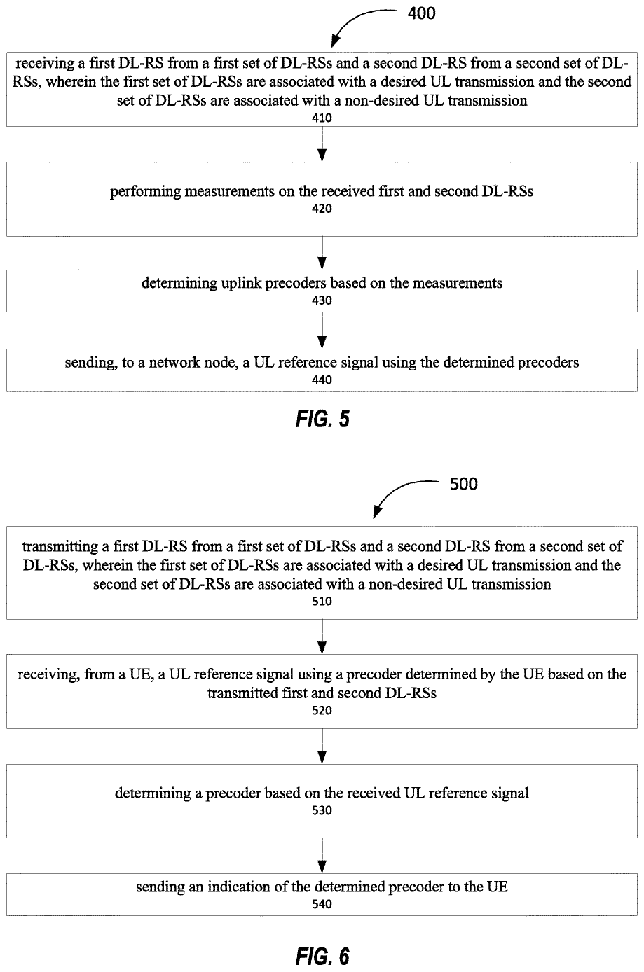

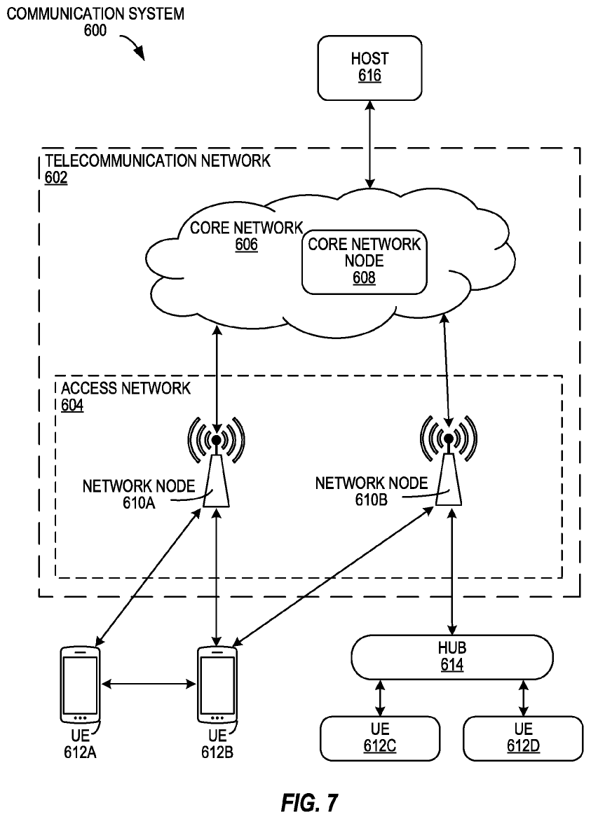

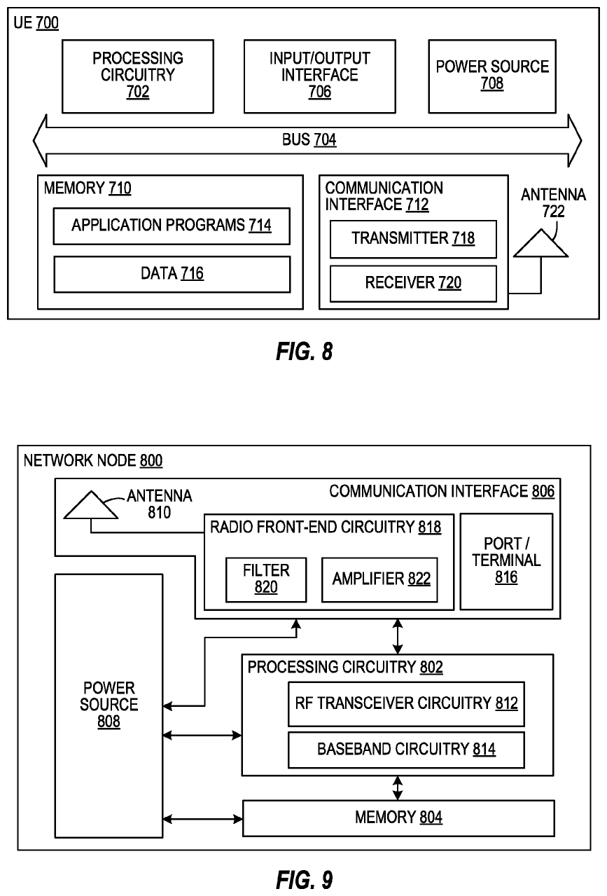

FIG. 5 illustrates an example of a flow chart of a method 400 for reciprocity-based interference aware UL transmissions. The method 400 can be implemented in a UE, such as CPE 50 or 60 of FIG. 1b, or UE 612 of FIG. 7 or UE 700 of FIG. 8. Method 400 comprises:

Step 410: receiving a first DL-RS from a first set of DL-RSs and a second DL-RS from a second set of DL-RSs, wherein the first set of DL-RSs are associated with a desired UL transmission and the second set of DL-RSs are associated with a non-desired UL transmission;

Step 420: performing measurements on the received first and second DL-RSs;

Step 430: determining uplink precoders based on the measurements; and

Step 440: sending, to a network node, a UL reference signal using the determined precoders.

In some examples, the UE may receive an indication of precoders from the network node, the precoders determined based on the UL reference signal sent to the network node. In some examples, the UE may send a physical uplink shared channel transmission to the network node using the received precoders. In some examples, the UE determines the uplink precoders by maximizing a transmitted power for UL signals in a direction associated with the received first DL-RS from the first set of DL-RSs. In some examples, the UE determines the uplink precoders by minimizing a transmitted power for UL signals in a direction associated with the received second DL-RS from the second set of DL-RSs. In some examples, the UE determines the uplink precoders by using SLNR or MMSE based on the first and second sets of DL-RSs.

In some examples, the second set of DL-RSs is based on non-zero power (NZP) DL-RS from transmission reception points (TRPs) other than a serving TRP. In some examples, the non-zero power DL-RS comprises a NZP CSI-RS. In some examples, the second set of DL-RSs indicate resources that are used to measure interference, but that are not dedicated DL-RSs actually transmitted from interfering TRPs. In some examples, the second set of DL-RSs comprise CSI-IM. In some examples, the second set of DL-RSs comprise both non-zero power DL-RS from TRPs other than a serving TRP and resources that are used to measure interference, but that are not dedicated DL-RSs actually transmitted from interfering TRPs. In some examples, the first set of DL-RSs and second set of DL-RSs are associated with a set of uplink (UL)-RSs. In some examples, the number of DL-RSs in the first and second set of DL-RSs is one or more than one. In some examples, a set of UL-RSs is configured by one or more UL-RS resource sets. In some examples, each UL-RS resource set comprises one or more UL-RS resources. In some examples, the UE may receive a configuration of DL-RS for the first and second set of DL-RSs. The UE may also receive a configuration of the UL-RSs. In some examples, the UE may send a UE capability to the network, the UE capability comprising an indication of capability for interference aware UL transmissions.

FIG. 6 illustrates an example of a flow chart of a method 500 for reciprocity-based interference aware UL transmissions. The method 500 can be implemented in a network node comprising two or more TRPs, such as TRP 55 and 65 of FIG. 1b. The network node can be the network node 610 of FIG. 7 or network 800 of FIG. 9. Method 500 comprises:

Step 510: transmitting a first DL-RS from a first set of DL-RSs and a second DL-RS from a second set of DL-RSs, wherein the first set of DL-RSs are associated with a desired UL transmission and the second set of DL-RSs are associated with a non-desired UL transmission;

Step 520: receiving, from a UE, a UL reference signal using a precoder determined by the UE based on the transmitted first and second DL-RSs;

Step 530: determining a precoder based on the received UL reference signal; and

Step 540: sending an indication of the determined precoder to the UE.

In some examples, the network node may receive a physical uplink shared channel transmission from the UE using the determined precoder. In some examples, the second set of DL-RSs is based on non-zero power (NZP) DL-RS from transmission reception points (TRPs) other than a serving TRP. In some examples, the non-zero power DL-RS comprises a NZP Channel State Information (CSI)-RS. In some examples, the second set of DL-RSs indicate resources used to measure interference, but that are not dedicated DL-RSs actually transmitted from interfering TRPs. In some examples, the second set of DL-RSs comprise CSI-IM. In some examples, the second set of DL-RSs comprise both non-zero power DL-RS from TRPs other than a serving TRP and resources that are used to measure interference, but that are not dedicated DL-RSs actually transmitted from interfering TRPs. In some examples, the first set of DL-RSs and second set of DL-RSs are associated with a set of uplink (UL)-RSs. In some examples, the number of DL-RSs in the first and second set of DL-RSs is one or more than one. In some examples, a set of UL-RSs is configured by one or more UL-RS resource sets. In some examples, each UL-RS resource set comprises one or more UL-RS resources. In some examples, the network node may send a configuration of DL-RS for the first and second set of DL-RSs. It can also send a configuration for the UL-RSs to the UE.

FIG. 7 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar 3GPP access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of UE, such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 7 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., 6G); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, NR, and LTE, i.e., being configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

FIG. 8 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, etc. Other examples include any UE identified by the 3GPP, including a Narrowband NB-IoT UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device.

The UE 700 includes processing circuitry 702 that is operatively coupled via a bus 704 to an input/output interface 707, a power source 708, memory 710, a communication interface 712, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs). The processing circuitry 702 may be configured to perform any steps of method 400 of FIG. 5.

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE.

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 8.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 9 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs (NBs), evolved NBs (eNBs), NR NBs (gNBs)) and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a NB component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NBs. In such a scenario, each unique NB and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality. The processing circuitry 802 may be configured to perform any steps of method 500 of FIG. 6.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 9 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

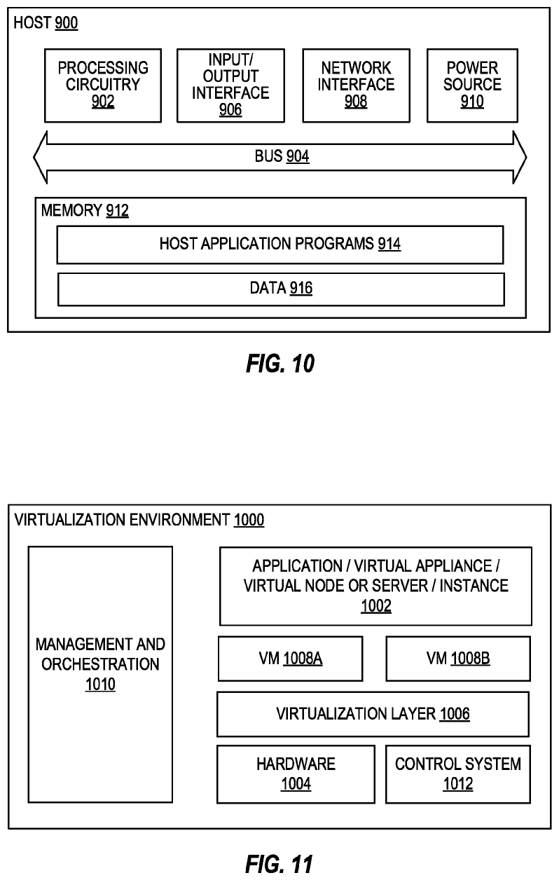

FIG. 10 is a block diagram of a host 900, which may be an embodiment of the host 616 of FIG. 8, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 909, a power source 910, and memory 912. Other components may be included in other embodiments. Features of these components may be substantially similar to those described with respect to the devices of previous figures, such as FIGS. 8 and 9, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 11 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1000 includes components defined by the O-RAN Alliance, such as an O-Cloud environment orchestrated by a Service Management and Orchestration Framework via an O-2 interface.

Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 1012 which may alternatively be used for communication between hardware nodes and radio units.

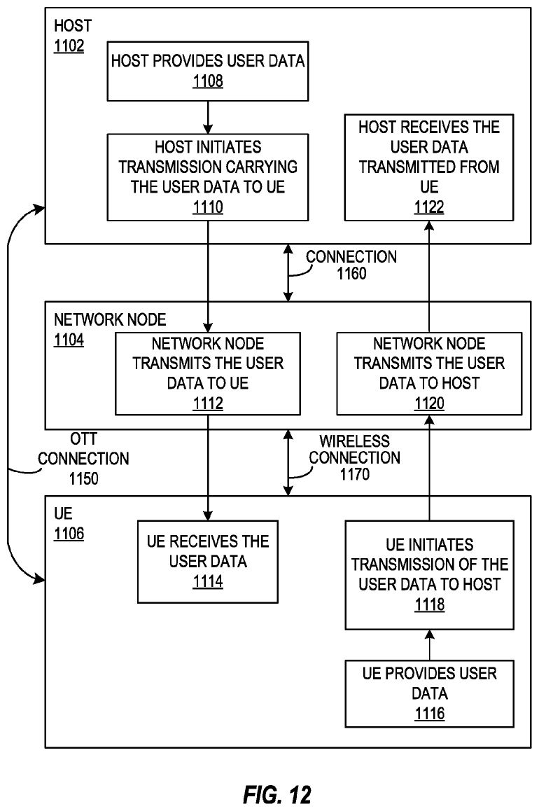

FIG. 12 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 7 and/or the UE 700 of FIG. 8), the network node (such as the network node 610A of FIG. 7 and/or the network node 800 of FIG. 9), and the host (such as the host 616 of FIG. 7 and/or the host 900 of FIG. 10) discussed in the preceding paragraphs will now be described with reference to FIG. 12.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106. The connection 1160 may be direct or pass through a core network (like the core network 606 of FIG. 7) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

1. A method performed by a user equipment (UE) for transmitting and/or receiving, the method comprising:
receiving a first downlink reference signal (DL-RS) from a first set of DL-RSs and a second DL-RS from a second set of DL-RSs, wherein the first set of DL-RSs are associated with a desired uplink (UL) transmission and the second set of DL-RSs are associated with a non-desired UL transmission;
performing measurements on the received first and second DL-RSs;
determining a first precoder based on the measurements; and
sending, to a network node, a UL reference signal using the determined first precoder.

2. The method of claim 1, further comprising receiving an indication of a second precoder from the network node, the second precoder determined based on the UL reference signal sent to the network node.

3. The method of claim 2, further comprising sending a physical uplink shared channel transmission to the network node using the second precoder.

4. The method of claim 1, wherein determining the first precoder comprises maximizing a transmitted power for UL signals in a direction associated with the received first DL-RS from the first set of DL-RSs.

5. The method of claim 1, wherein determining the first precoder comprises minimizing a transmitted power for UL signals in a direction associated with the received second DL-RS from the second set of DL-RSs.

6. The method of claim 1, wherein determining the first precoder comprises using Signal-to-Leakage-and-Noise Ratio (SLNR) or Minimum Mean Squared Error (MMSE) based on the first and second sets of DL-RSs.

7. The method of claim 1, wherein the second set of DL-RSs is based on non-zero power (NZP) DL-RS from transmission reception points (TRPs) other than a serving TRP.

8. (canceled)

9. The method of claim 1, wherein the second set of DL-RSs indicate resources that are used to measure interference, but that are not dedicated DL-RSs actually transmitted from interfering TRPs.

10. The method of claim 9, wherein the second set of DL-RSs comprise CSI-IM.

11. (canceled)

12. The method of claim 1, wherein the first set of DL-RSs and second set of DL-RSs are associated with a set of uplink (UL)-RSs.

13. (canceled)

14. (canceled)

15. (canceled)

16. The method of claim 1, further comprising receiving a configuration of DL-RS for the first and second set of DL-RSs and/or a configuration of UL-RSs.

17. (canceled)

18. The method of claim 1, further comprising sending a UE capability to the network, the UE capability comprising an indication of capability for interference aware UL transmissions.

19. A method performed by a network node, for transmitting and/or receiving, the method comprising:
transmitting a first downlink reference signal (DL-RS) from a first set of DL-RSs and a second DL-RS from a second set of DL-RSs, wherein the first set of DL-RSs are associated with a desired uplink (UL) transmission and the second set of DL-RSs are associated with a non-desired UL transmission;
receiving, from a user equipment (UE), a UL reference signal using a first precoder determined by the UE based on the transmitted first and second DL-RSs;
determining a second precoder based on the received UL reference signal; and
sending an indication of the determined second precoder to the UE.

20. The method of claim 19, further comprising receiving a physical uplink shared channel transmission from the UE using the determined second precoder.

21. The method of claim 19, wherein the second set of DL-RSs is based on non-zero power (NZP)DL-RS from transmission reception points (TRPs) other than a serving TRP.

22. (canceled)

23. The method of claim 19, wherein the second set of DL-RSs indicate resources used to measure interference, but that are not dedicated DL-RSs actually transmitted from interfering TRPs.

24. The method of claim 23, wherein the second set of DL-RSs comprise CSI-IM.

25. (canceled)

26. The method of claim 19, wherein the first set of DL-RSs and second set of DL-RSs are associated with a set of uplink (UL)-RSs.

27. (canceled)

28. (canceled)

29. (canceled)

30. The method of claim 19, further comprising sending a configuration of DL-RS for the first and second set of DL-RSs and/or configuration of UL-RSs to the UE.

31. (canceled)

32. A user Equipment (UE) comprising processing circuitry and network interface, the processing circuitry configured to:
receive a first downlink reference signal (DL-RS) from a first set of DL-RSs and a second DL-RS a second set of DL-RSs, wherein the first set of DL-RSs are associated with a desired uplink (UL) transmission and the second set of DL-RSs are associated with a non-desired UL transmission;
perform measurement on the received first and second DL-RSs,
determine a first precoder based on the measurements; and
send, to a network node, a UL reference signal using the precoder.

33. (canceled)

34. (canceled)
